(19) United States
(12) Patent Application Publication
(10) Pub. No.: US 2007/0178363 A1
(43) Pub. Date: Aug. 2, 2007

(54) Anode catalyst for polymer electrolyte fuel cell

(75) Inventors: Naoko Fujiwara, Osaka (JP); Kazuaki Yasuda, Osaka (JP); Atsushi Ueda, Osaka (JP); Yoshinori Miyazaki, Osaka (JP); Tsutomu Tanimitsu, Osaka (JP); Yukino Shiozaki, Osaka (JP)

Correspondence Address: POSZ LAW GROUP, PLC, 12040 SOUTH LAKES DRIVE, SUITE 101, RESTON, VA, 20191, US

(73) Assignees: National Institute of Advanced Industrial Science and Technology, Tokyo (JP); Nippon Kagaku Yakin Co., Ltd., Osaka (JP)

(21) Appl. No.: 10/592,000

(22) PCT Filed: Mar. 4, 2005
(86) PCT No.: PCT/JP05/03736

§ 371 Date: Sep. 7, 2006

(30) Foreign Application Priority Data
Mar. 12, 2004 (JP) 2004-070260

(51) Int. Cl. H01M 4/92; H01M 4/88

(52) U.S. Cl. 429/44; 502/101

(57) ABSTRACT

Disclosed are a method for producing an anode catalyst for a polymer electrolyte fuel cell, comprising a first supporting step of adhering at least one element selected from the group consisting of the elements of group 4, elements of group 5 and elements of group 6 of the periodic table to a conductive support, and subsequently conducting a heat treatment in a non-oxidizing atmosphere, and a second supporting step of adhering platinum and ruthenium on the support obtained in the first supporting step, and subsequently conducting a heat treatment in a non-oxidizing atmosphere; and an anode catalyst for a polymer electrolyte fuel cell obtainable in accordance with this method, the catalyst comprising catalytic metal components supported in a highly dispersed manner on a conductive support. The catalyst provided in accordance with the present invention exhibits excellent performance as an anode catalyst for a polymer electrolyte fuel cell, and more particularly, excellent carbon monoxide oxidation properties and alcohol oxidation properties.

### TECHNICAL FIELD

The present invention relates to an anode catalyst for a polymer electrolyte fuel cell, and a method for preparing the anode catalyst.

### BACKGROUND ART

Polymer electrolyte fuel cells have attracted attention as small portable power sources because of their capabilities of being operable at low temperatures and being miniaturized. In addition to hydrogen gas, fuel sources for polymer electrolyte fuel cells include reformed gases obtained by reforming natural gas, methanol and the like. Methanol is also directly used as a liquid fuel.

However, catalytic poisons such as carbon monoxide are contained in the reformed gases. The use of methanol as a liquid fuel also causes catalyst poisoning in the methanol oxidization process. Therefore, the use of fuels such as reformed gases and methanol has a drawback in that the catalytic performance is substantially degraded in the course of use.

Platinum/ruthenium is known as a catalyst excellent in carbon monoxide oxidation and methanol oxidation, but its catalytic performance is not sufficient so as to be of practical use for fuel cells, and therefore, further improvements are desired.

Known catalysts with improved carbon monoxide oxidation and methanol oxidation properties include a catalyst comprising platinum, ruthenium and a third component as catalytic components, wherein the catalytic components are supported on a conductive support such as carbon. For example, Patent Publication 1 listed below discloses a method for preparing an anode catalyst which employs a solution containing a platinum salt, a ruthenium salt, and a salt of metal such as ruthenium, tantalum or gold as a third component, wherein the three components are simultaneously supported on a conductive support. This method, however, produces a catalyst with less homogeneity because a platinum-tantalum alloy and the like are formed other than the platinum-ruthenium-based alloy effective at oxidizing carbon monoxide and methanol, which makes it difficult to obtain a catalyst with sufficient resistance to the poisoning caused by carbon monoxide.

Moreover, Patent Publications 2 and 3 listed below disclose a method for preparing an alloy catalyst, comprising the steps of supporting first platinum, secondly ruthenium, and thirdly molybdenum or tungsten on a carbon material. The drawbacks of these methods are that a number of heat treatments are necessary because of the three metal-supporting steps, and that the heat treatment temperatures are as high as from about 600 to about 900° C., which cause catalyst particle growth to readily reduce the catalyst activity.
Patent Publication 1: U.S. Pat. No. 3506494
Patent Publication 2: Japanese Unexamined Patent Publication No. 2001-15120
Patent Publication 3: Japanese Unexamined Patent Publication No. 2001-15121

### DISCLOSURE OF THE INVENTION

### Problem to be Solved by the Invention

The present invention has been accomplished in view of the current state of prior art as described above. A principal object of the present invention is to provide an anode catalyst for a polymer electrolyte fuel cell having excellent performance, and more particularly, an anode catalyst excellent in carbon monoxide oxidation and alcohol oxidation.

### Means for Solving the Problem

The present inventors conducted extensive research in order to achieve the aforementioned object. As a result, the inventors found that a catalyst containing uniformly and highly dispersed metal components, compared with catalysts obtained by conventional processes, can be obtained by a two-stage supporting process, comprising supporting at least one element selected from the group consisting of the elements of group 4, elements of group 5 and elements of group 6 of the periodic table on a conductive support; and supporting platinum and ruthenium on the support, wherein in each supporting step, a heat treatment is conducted at a relatively low temperature in a non-oxidizing atmosphere. The resulting catalyst was found to exhibit excellent performance as an anode catalyst for a polymer electrolyte fuel cell, and exhibit, in particular, satisfactory carbon monoxide oxidation properties and methanol oxidation properties. The present invention has been accomplished based on these findings.

The present invention provides an anode catalyst for a polymer electrolyte fuel cell and a production method therefor, as itemized below.
1. A method for producing an anode catalyst for a polymer electrolyte fuel cell, comprising a first supporting step of adhering at least one element selected from the group consisting of the elements of group 4, elements of group 5 and elements of group 6 of the periodic table to a conductive support, and subsequently conducting a heat treatment in a non-oxidizing atmosphere; and a second supporting step of adhering platinum and ruthenium on the support obtained in the first supporting step, and subsequently conducting a heat treatment in a non-oxidizing atmosphere.
2. The method according to Item 1, wherein the heat-treatment temperature in each of the first and second supporting steps is from 200 to 600° C.
3. An anode catalyst for a polymer electrolyte fuel cell, comprising, as catalytic metal components, platinum, ruthenium and at least one element selected from the group consisting of the elements of group 4, elements of group 5 and elements of group 6 of the periodic table supported on a conductive support as obtained by the method according to Item 1.
4. An anode catalyst for a polymer electrolyte fuel cell, comprising, as catalytic metal components, platinum, ruthenium and at least one element selected from the group consisting of the elements of group 4, elements of group 5 and elements of group 6 of the periodic table supported on a conductive support, wherein the specific surface area of the catalytic metal components is 60 to 350 m²/g.
5. A polymer electrolyte fuel cell comprising the anode catalyst according to Item 3.
6. A polymer electrolyte fuel cell comprising the anode catalyst according to Item 4.

Detailed description is made below of the method for preparing an anode catalyst for a polymer electrolyte fuel cell in accordance with the present invention, and an anode catalyst prepared by the method.

Anode Catalyst Preparation Method

The preparation method of the present invention necessitates a two-step supporting method which comprises a first supporting step of supporting at least one element selected from the group consisting of the elements of group 4, elements of group 5 and elements of group 6 of the periodic table (which may hereinafter be termed “third component(s)”) on a conductive support; and a second supporting step of supporting platinum and ruthenium on the support. Each of the steps is described in detail below.

(1) Supports

Examples of conductive supports are not particularly limited, and include a variety of supports conventionally employed in anode catalysts for polymer electrolyte fuel cells. Carbon black is preferable for use as a support in the present invention because of its good corrosion resistance, electrical conductivity, and large specific surface area. Carbon black with a BET surface area from about 200 to about 1000 m²/g is especially preferable. A specific example of such a support is carbon black available under the trade name Vulcan XC-72 (manufactured by Cabot Corporation).

(2) First Supporting Step

The first supporting step comprises adhering a third component (i.e., at least one element selected from the group consisting of the elements of group 4, elements of group 5 and elements of group 6 of the periodic table) to a conductive support, and subsequently conducting a heat treatment in a non-oxidizing atmosphere.

The method for adhering a third component to a conductive support is not particularly limited, but the third component can be efficiently adhered, typically by immersing the conductive support in a third component-containing solution.

Specific examples of third components include the elements of group 4 of the periodic table, such as titanium, zirconium and hafnium; the elements of group 5 such as vanadium, niobium and tantalum; and the elements of group 6 such as chromium, molybdenum and tungsten. Such elements may be supported singly or as a combination of two or more.

Among these elements, titanium, zirconium, vanadium, niobium, tantalum, chromium, molybdenum, and tungsten, for example, exhibit especially good catalytic performances.

Any type of solution may be used for supporting the third component, provided that it includes a third component-containing compound homogenously dissolved therein. Examples of usable solvents include water; a variety of organic solvents, such as methanol, ethanol, 1-propanol, 2-propanol, cyclohexane, acetone, γ-butyl lactone, dichloromethane, methyl acetate, toluene, acetonitrile, etc; and mixtures thereof.

Any type of third component-containing compound may be used, provided that it dissolves in the solvent used. For example, when a solvent such as water or an alcohol is used, a chloride may be used, e.g., titanium chloride, vanadium chloride, chromium chloride, zirconium chloride, niobium chloride, molybdenum chloride, hafnium chloride, tantalum chloride, tungsten chloride, etc.

The concentration of the third component-containing compound in the solution is not particularly limited, but typically, when the concentration of the compound is from about 1 to about 10 wt. % as calculated in terms of metal content, the metal can be efficiently supported.

The amount of conductive support may be determined based on the desired amount of third component to be supported, because in the process of removing solvent by evaporation described below, substantially the entire amount of third component in the solution can be directly supported on the support.

A support is immersed in a third component-containing solution as above, and is uniformly dispersed by thoroughly stirring. The solvent is subsequently removed, and then a heat treatment is performed in a non-oxidizing atmosphere.

Solvent may be removed by any process, but is typically removed by evaporation at a temperature below the boiling point of the solvent used, e.g., a temperature which is about 5 to about 20° C. lower than the boiling point.

The heat treatment atmosphere may be any non-oxidizing atmosphere, inclusive of an atmosphere of an inert gas such as nitrogen, noble gas, etc., or an atmosphere of a reducing gas such as hydrogen gas, etc.

For example, a heat treatment may be conducted in a stream of a gas, such as an inert gas, hydrogen gas or mixture thereof, at a flow rate of from about 2 to 500 ml/min, and preferably from about 20 to about 100 ml/min, although it may be performed in various other conditions.

The heat treatment temperature is preferably from about 200 to about 600° C., and more preferably from about 250 to about 350° C. Heat-treating at such relatively low temperature ranges inhibits third component growth, thereby allowing the third component to be finely and uniformly dispersed.

The temperature elevating rate during heat treatment is not particularly limited, but a suitable range is from about 10 to about 200° C./hr, and preferably from about 50 to about 100° C./hr, in order to avoid abrupt heating.

The heat treatment time is not particularly limited, but is typically from about 10 minutes to about 5 hours, and preferably from about 1 to about 3 hours, at an aforementioned temperature range.

(3) Second Supporting Step

In the subsequent step, platinum and ruthenium are supported on the third component-containing support prepared as above.

Platinum and ruthenium may be supported by adhering the platinum and ruthenium on the third component-containing support obtained in the first supporting step, and subsequently heat-treating the support in a non-oxidizing atmosphere.

The method for adhering platinum and ruthenium to the third component-containing support obtained in the first supporting step is not particularly limited, but these elements can be efficiently adhered, typically by immersing the support in a solution containing platinum and ruthenium as in the first supporting step.

A solution which comprises a platinum-containing compound and a ruthenium-containing compound uniformly dissolved therein may be used as the solution containing platinum and ruthenium.

As in the first supporting step, examples of usable solvents include water; a variety of organic solvents, such as methanol, ethanol, 1-propanol, 2-propanol, cyclohexane, acetone, γ-butyl lactone, dichloromethane, methyl acetate, toluene, acetonitrile, etc; and mixtures thereof.

Examples of platinum-containing compounds include hexachloroplatinic acid, sodium hexachloroplatinate (IV), sodium hexahydroxoplatinate (IV), potassium tetrachloroplatinate (II), tris(ethylenediamine)platinum chloride, hexaammineplatinum chloride, chloropentaammineplatinum chloride, chlorotrisammineplatinum chloride, ammonium hexachloroplatinate, cis -dichlorobis(pyrazine)platinum, cis-dichlorobis(4,4′-bipyridine)platinum, cis-dichlorobis(pyridine)platinum, trichloro(pyrazine)platinate, trichloro(4,4-bipyridine)platinate, trans-dichlorodiammineplatinum, dinitrodiammineplatinum, nitroammineplatinum ethoxide, ammineplatinum (IV) solution, hexahydroxoplatinate, potassium tetranitroplatinate, potassium bis(oxalato)platinate, 1,5-cyclooctadienedimethylplatinum, etc.; and examples of ruthenium-containing compounds include ruthenium chloride, hexaammineruthenium chloride, potassium hexachlororuthenate, potassium hexachlororuthenate, cis-dichloro(2,2-bipyridine)ruthenium, tris(2,2-bipyridine)ruthenium chloride, tris(1,10-phenanthroline) ruthenium chloride, chloropentaammineruthenium chloride, acetylacetone ruthenium, tris(diamine)ruthenium chloride, (pyrazine)ruthenium chloride, (4,4-bipyridine)ruthenium chloride, (4,4-bipyridine)ruthenium hexafluorophosphate, ruthenium nitrate, ruthenium red, triruthenium dodecacarbonyl, bis-cyclopentadienyl ruthenium, etc. Specific compounds for use may be suitably selected according to the kind of solvent used.

The concentration of platinum-containing compound and ruthenium-containing compound is not particularly limited, but typically, when the concentration of platinum metal and ruthenium metal in total is from about 1 to about 10 wt. %, these metals can be efficiently adhered.

The proportion of platinum-containing compound to ruthenium-containing compound is preferably such that the amount of ruthenium metal is from about 25 to about 105 wt. parts, and more preferably from about 25 to about 55 wt. parts, per 100 wt. parts of platinum metal.

A catalyst of the present invention is obtainable in accordance with the following procedure: the support is immersed in a solution containing platinum and ruthenium as above, and the support is uniformly dispersed by thoroughly stirring. The solvent is subsequently removed, and then a heat treatment is performed in a non-oxidizing atmosphere.

Solvent may be removed in the manner as described in the first supporting step.

The heat treatment temperature may be the same as that in the first supporting step, i.e., preferably from about 200 to about 600° C., and more preferably from about 250 to about 350° C. Other heating conditions are also the same as those in the first supporting step.

Anode Catalyst

In accordance with the aforementioned procedure, a catalyst comprising catalytic metals, i.e., platinum, ruthenium and a third component, supported in a uniformly and highly dispersed manner on a conductive support can be obtained.

The amount of third component used in the catalyst of the invention is preferably from about 10 to about 150 wt. parts, and more preferably from about 10 to about 45 wt. parts, per 100 wt. parts of platinum metal and ruthenium metal in total. Such ranges of third component will impart a satisfactory performance to the catalyst.

The amount of supported catalytic metals, i.e., platinum, ruthenium and third component, is not particularly limited, but the total amount of platinum, ruthenium and third component is typically from about 25 to about 400 wt. parts, and preferably from about 65 to about 150 wt. parts, per 100 wt. parts of conductive support.

The above-described two-step supporting method permits the specific surface area of supported catalytic metals to be greatly increased, and the fine catalytic metals to be uniformly and highly dispersed, as compared with the method of supporting three catalytic metals in a single step. Such a catalyst exhibits excellent activity as an anode catalyst for a polymer electrolyte fuel cell, and provides, in particular, excellent carbon monoxide oxidation properties and methanol oxidation properties.

In accordance with the present method, a catalyst comprising very fine catalytic metals with a specific surface area of 60 m²/g or more can be obtained, which has heretofore been impossible for a catalyst containing platinum, ruthenium and a third component. More particularly, a catalyst comprising catalytic metals with an unprecedentedly large specific surface area, i.e., from about 60 to about 350 m²/g, is attained. Such a large specific surface area is achieved by heat treating at relatively low temperatures. This specific surface area can be further increased by suitably controlling the preparation conditions. Such a catalyst exhibits excellent activity as an anode catalyst for a polymer electrolyte fuel cell, and provides, in particular, excellent carbon monoxide oxidation properties and methanol oxidation properties. Note that the specific surface area of catalytic metals in the specification is evaluated by stripping voltammetry, in which the specific surface area is determined based on the amount of carbon monoxide adsorbed.

A catalyst of the present invention contains finely and uniformly supported catalytic metals, i.e., platinum, ruthenium and a third component, without agglomeration. For example, such a catalyst comprises finely dispersed catalytic metals, wherein the particle size of 80% or more of the catalytic metals is from 2 to 5 nm as determined based on transmission electron micrographs.

As noted above, the catalyst in accordance with the present invention contains uniformly and highly dispersed fine catalytic metals with a large specific surface area, compared with catalysts obtained by conventional processes. Such a catalyst exhibits excellent performance as an anode catalyst for a polymer electrolyte fuel cell, and provides, in particular, excellent carbon monoxide oxidation properties and methanol oxidation properties. Accordingly, a polymer electrolyte fuel cell using the anode catalyst of the present invention exhibits excellent performance even when it operates on a fuel such as a carbon monoxide-containing reformed gas or liquid methanol.

The polymer electrolyte fuel cell using the catalyst of the invention may employ any kind of configuration, and the same configuration as those of known fuel cells except for using the anode catalyst of the present invention may be applied.

### EFFECTS OF THE INVENTION

In accordance with the present invention, a catalyst comprising catalytic metals, i.e., platinum, ruthenium and a third component, uniformly supported on a conductive support in a highly dispersed manner can be obtained.

The present catalyst exhibits excellent performance as an anode catalyst for a polymer electrolyte fuel cell, and provides, in particular, excellent carbon monoxide oxidation properties and methanol oxidation properties.

### BRIEF DESCRIPTION OF THE DRAWINGS

FIG. 1 shows a drawing prepared by printing out the electronic data of a transmission electron micrograph of the catalyst obtained in Example 8.

FIG. 2 shows a drawing prepared by printing out the electronic data of a transmission electron micrograph of the catalyst obtained in Comparative Example 8.

### BEST MODE FOR CARRYING OUT THE INVENTION

The present invention is hereinafter described in further details through the following Examples.

### EXAMPLE 1

500 mg of carbon black (tradename: Vulcan XC 72R, manufactured by Cabot Corporation; specific surface area: 230 m²/g) was added to 1000 ml of an ethanol solution containing titanium chloride having a titanium-metal content of 100 mg. The mixture was then thoroughly stirred to form a uniform dispersion, which was heated to 55° C. with stirring, so as to remove ethanol by evaporation. The resulting residue was then heated for 3 hours at 300° C. in a stream of hydrogen gas at a flow rate of 50 ml/min, thereby supporting titanium on the carbon black.

Next, 300 ml of a cyclohexane solution containing 1,5-cyclooctadienedimethylplatinum having a platinum-metal content of 317.7 mg was mixed with 40 ml of an ethanol solution containing ruthenium chloride having a ruthenium-metal content of 82.3 mg. To the mixture was added the obtained carbon having titanium supported thereon, and the resulting mixture was thoroughly stirred to form a uniform dispersion. The dispersion was heated to 55° C. with stirring, so as to remove solvent by evaporation. The resulting residue was heated for 3 hours at 300° C. in a stream of hydrogen gas at a flow rate of 50 ml/min, thereby supporting platinum, ruthenium and titanium on the carbon black.

The resulting support having the catalytic metals thereon was measured by stripping voltammetry to determine the peak potential in carbon monoxide oxidation. More specifically, an electrode comprising the obtained support fixed on a carbon substrate with Nafion resin (trademark of Du Pont) was used. This electrode was held at 0.05 V (vs standard hydrogen electrode potential) in a 0.5 mol/l H₂SO₄ electrolyte at 25° C., into which carbon monoxide was introduced for 5 minutes, thereby causing the carbon monoxide to be completely adsorbed over the catalytic metal surface. The electrolyte was subsequently purged with argon gas for 10 minutes in order to remove excess carbon monoxide, and the peak potential in carbon monoxide oxidation was measured by scanning the potential, from 0.05 to 0.8 V, at a rate of 20 mV/sec. On the basis of this measurement, the amount of electricity corresponding to carbon monoxide oxidation was determined from the peak area in carbon monoxide oxidation. The result was subsequently divided by Coulombs (420 μC cm⁻²) necessary for oxidation of the monomolecular layer of carbon monoxide that is directly adsorbed on the catalyst, so as to evaluate the specific surface area of the catalytic metals.

In addition, the methanol oxidation current density at 0.5 V (vs standard hydrogen electrode potential) was determined by cyclic voltammetry, in which the potential was scanned from 0.05 to 0.8 V at 1 mV/sec. The results-are shown in Table 1 below.

### EXAMPLE 2

Platinum, ruthenium and vanadium were supported on carbon black as in Example 1, except for using 1000 ml of an ethanol solution containing vanadium chloride having a vanadium-metal content of 100 mg instead of the titanium chloride-containing ethanol solution used in Example 1.

The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are shown in Table 1 below.

### EXAMPLE 3

Platinum, ruthenium and chromium were supported on carbon black as in Example 1, except for using 1000 ml of an ethanol solution containing chromium chloride having a chromium-metal content of 100 mg instead of the titanium chloride-containing ethanol solution used in Example 1.

The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are shown in Table 1 below.

### EXAMPLE 4

Platinum, ruthenium and zirconium were supported on carbon black as in Example 1, except for using 1000 ml of an ethanol solution containing zirconium chloride having a zirconium-metal content of 100 mg instead of the titanium chloride-containing ethanol solution used in Example 1.

The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are shown in Table 1 below.

### EXAMPLE 5

Platinum, ruthenium and niobium were supported on carbon black as in Example 1, except for using 1000 ml of an ethanol solution containing niobium chloride having a niobium-metal content of 100 mg instead of the titanium chloride-containing ethanol solution used in Example 1.

The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are shown in Table 1 below.

### EXAMPLE 6

Platinum, ruthenium and molybdenum were supported on carbon black as in Example 1, except for using 1000 ml of an ethanol solution containing molybdenum chloride having a molybdenum-metal content of 100 mg instead of the titanium chloride-containing ethanol solution used in Example 1.

The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are shown in Table 1 below.

### EXAMPLE 7

Platinum, ruthenium and tungsten were supported on carbon black as in Example 1, except for using 1000 ml of an ethanol solution containing tungsten chloride having a tungsten-metal content of 100 mg instead of the titanium chloride-containing ethanol solution used in Example 1. The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are shown in Table 1 below.

### EXAMPLE 8

Platinum, ruthenium and tantalum were supported on carbon black as in Example 1, except for using 1000 ml of an ethanol solution containing tantalum chloride having a tantalum-metal content of 100 mg instead of the titanium chloride-containing ethanol solution used in Example 1. The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are shown in Table 1 below.

### EXAMPLE 9

Platinum, ruthenium and tantalum were supported on carbon black as in Example 1, except for using 1000 ml of an ethanol solution containing tantalum chloride having a tantalum-metal content of 100 mg instead of the titanium chloride-containing ethanol solution used in Example 1; and 300 ml of a cyclohexane solution containing chloroplatinic acid having a platinum-metal content of 317.7 mg instead of the 1,5-cyclooctadienedimethylplatinum-containing cyclohexane solution of Example 1.

The resulting support having the catalytic metals thereon was measured to determine the specific surface area of the catalyst metal components, the carbon monoxide oxidation peak potential, and the methanol oxidation current density at 0.5 V (vs standard hydrogen electrode potential), as in Example 1. The results are shown in Table 1 below.

### EXAMPLE 10

Platinum, ruthenium and tantalum were supported on carbon black as in Example 1, except for using 1000 ml of an ethanol solution containing tantalum chloride having a tantalum-metal content of 100 mg instead of the titanium chloride-containing ethanol solution used in Example 1; and 40 ml of an ethanol solution containing ruthenium nitrate having a ruthenium-metal content of 82.3 mg instead of the ruthenium chloride-containing ethanol solution of Example 1.

The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are shown in Table 1 below.

### COMPARATIVE EXAMPLE 1

300 ml of a cyclohexane solution containing 1,5-cyclooctadienedimethylplatinum having a platinum-metal content of 317.7 mg; 40 ml of an ethanol solution containing ruthenium chloride having a ruthenium-metal content of 82.3 mg; and 1000 ml of an ethanol solution containing titanium chloride having a titanium-metal content of 100 mg were mixed. To the mixture was added 500 mg of carbon black the same as that used in Example 1, and the mixture was heated with stirring to 55° C., so as to remove solvent by evaporation.

The resulting residue was heated for 3 hours at 300° C. in a stream of hydrogen gas at a flow rate of 50 ml/min, thereby supporting platinum, ruthenium and titanium on the carbon black.

The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are shown in Table 1 below.

### COMPARATIVE EXAMPLE 2

Platinum, ruthenium and vanadium were supported on carbon black as in Comparative Example 1, except for using 1000 ml of an ethanol solution containing vanadium chloride having a vanadium-metal content of 100 mg instead of the titanium chloride-containing ethanol solution used in Comparative Example 1.

The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are shown in Table 1 below.

### COMPARATIVE EXAMPLE 3

Platinum, ruthenium and chromium were supported on carbon black as in Comparative Example 1, except for using 1000 ml of an ethanol solution containing chromium chloride having a chromium-metal content of 100 mg instead of the titanium chloride-containing ethanol solution used in Comparative Example 1.

The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are shown in Table 1 below.

### COMPARATIVE EXAMPLE 4

Platinum, ruthenium and zirconium were supported on carbon black as in Comparative Example 1, except for using 1000 ml of an ethanol solution containing zirconium chloride having a zirconium-metal content of 100 mg instead of the titanium chloride-containing ethanol solution used in Comparative Example 1.

The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are-shown in Table 1 below.

### COMPARATIVE EXAMPLE 5

Platinum, ruthenium and niobium were supported on carbon black as in Comparative Example 1, except for using 1000 ml of an ethanol solution containing niobium chloride having a niobium-metal content of 100 mg instead of the titanium chloride-containing ethanol solution used in Comparative Example 1.

The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are shown in Table 1 below.

### COMPARATIVE EXAMPLE 6

Platinum, ruthenium and molybdenum were supported on carbon black as in Comparative Example 1, except for using 1000 ml of an ethanol solution containing molybdenum chloride having a molybdenum-metal content of 100 mg instead of the titanium chloride-containing ethanol solution used in Comparative Example 1.

The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are shown in Table 1 below.

### COMPARATIVE EXAMPLE 7

Platinum, ruthenium and tungsten were supported on carbon black as in Comparative Example 1, except for using 1000 ml of an ethanol solution containing tungsten chloride having a tungsten-metal content of 100 mg instead of the titanium chloride-containing ethanol solution used in Comparative Example 1.

The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are shown in Table 1 below.

### COMPARATIVE EXAMPLE 8

Platinum, ruthenium and tantalum were supported on carbon black as in Comparative Example 1, except for using 1000 ml of an ethanol solution containing tantalum chloride having a tantalum-metal content of 100 mg instead of the titanium chloride-containing ethanol solution used in Comparative Example 1.

The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are shown in Table 1 below.

### COMPARATIVE EXAMPLE 9

300 ml of a cyclohexane solution containing 1,5-cyclooctadienedimethylplatinum having a platinum-metal content of 317.7 mg was mixed with 40 ml of an ethanol solution containing ruthenium chloride having a ruthenium-metal content of 82.3 mg. To the mixture was added 500 mg of carbon black the same as that used in Example 1, and the mixture was heated with stirring to 55° C., so as to remove solvent by evaporation. The resulting residue was heated for 3 hours at 300° C. in a stream of hydrogen gas at a flow rate of 50 ml/min, thereby supporting platinum and ruthenium on the carbon black.

The resulting support having the catalytic metals thereon was measured to determine the specific surface area of the catalytic metals, the carbon monoxide oxidation peak potential, and the methanol oxidation current density at 0.5 V (vs standard hydrogen electrode potential), as in Example 1. The results are-shown in-Table 1 below.

TABLE 1

| | | Specific | CO Oxidation | Methanol |
|---|---|---|---|---|
| | | Surface | Peak | Oxidation Current |
| | | Area Deter- | Potential | Density |
| | | mined By | (V) | (mA/mg) at 0.5 V |
| | | Stripping | (vs Standard | (vs Standard |
| Example/ | Third | Voltam- | Hydrogen | Hydrogen |
| Comparative | Compo- | mogram | Electrode | Electrode |
| Example | nent | (m²/g) | Potential) | Potential) |
| Example 1 | Ti | 296 | 0.515 | 72 |
| Comparative | | 34 | 0.575 | 2 |
| Example 1 | | | | |
| Example 2 | V | 64 | 0.558 | 13 |
| Comparative | | 23 | 0.579 | 1 |
| Example 2 | | | | |
| Example 3 | Cr | 306 | 0.522 | 73 |
| Comparative | | 52 | 0.605 | 4.7 |
| Example 3 | | | | |
| Example 4 | Zr | 82 | 0.519 | 68 |
| Comparative | | 27 | 0.56 | 1.3 |
| Example 4 | | | | |
| Example 5 | Nb | 129 | 0.523 | 58 |
| Comparative | | 43 | 0.567 | 3.2 |
| Example 5 | | | | |
| Example 6 | Mo | 152 | 0.506 | 75 |
| Comparative | | 36 | 0.582 | 4.6 |
| Example 6 | | | | |
| Example 7 | W | 65 | 0.511 | 15 |
| Comparative | | 26 | 0.558 | 1.3 |
| Example 7 | | | | |
| Example 8 | Ta | 323 | 0.526 | 145 |
| Example 9 | | 252 | 0.526 | 61 |
| Example 10 | | 246 | 0.533 | 128 |
| Comparative | | 48 | 0.576 | 20 |
| Example 8 | | | | |
| Comparative | None | 38 | 0.591 | 18 |
| Example 9 | | | | |

As clearly seen from the results shown above, the catalysts obtained in accordance with the procedures of Examples 1 to 10 possess greater metal component specific surface areas and lower carbon monoxide oxidation peak potentials than those of the catalysts in Comparative Examples which were obtained by supporting platinum, ruthenium and a third component in a single step.

The term “carbon monoxide oxidation peak potential” denotes the potential at which carbon monoxide is oxidized and removed. These results demonstrate that the catalysts in all the Examples have less impairment of their catalytic performance, even in the presence of carbon monoxide, than the catalysts in Comparative Examples, and hence allow effective utilization of reformed gases or like carbon monoxide-containing fuels.

The term “methanol oxidation current density at 0.5 V” denotes the electric current density that can be obtained at 0.5 V, i.e., a voltage within the voltage range which is expected to be practically used. The catalysts in all the Examples exhibit higher methanol oxidation current densities than those of the catalysts of Comparative Examples using the same third component, revealing that these catalysts permit effective utilization of methanol as a fuel.

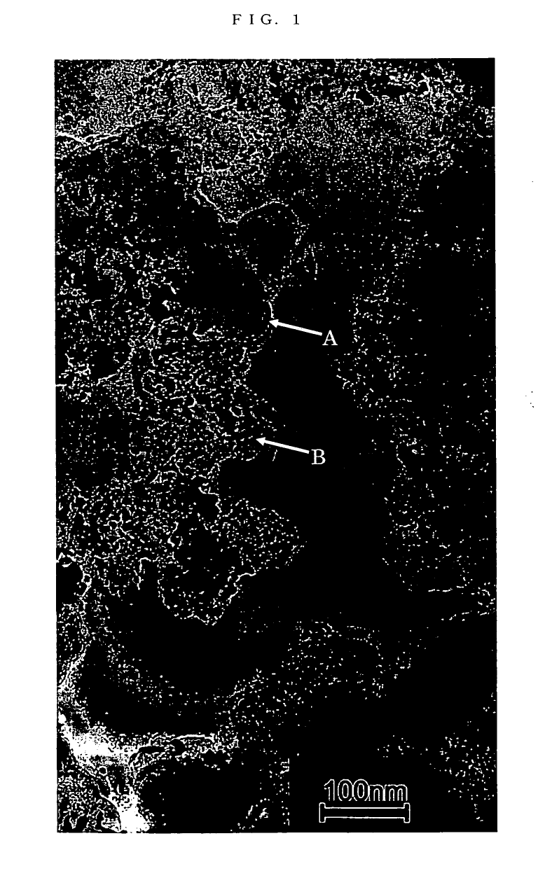

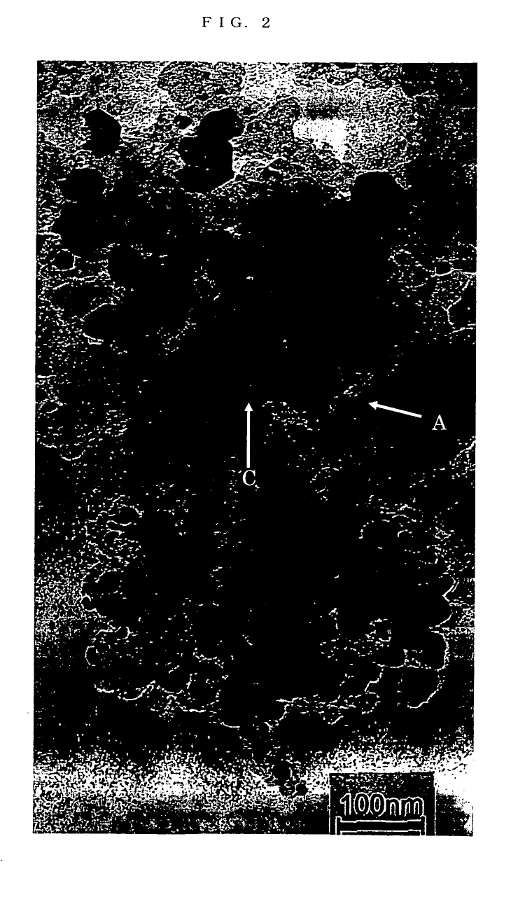

FIG. 1 and FIG. 2 show drawings prepared by printing out the electronic data of transmission electron micrographs obtained in Example 8 and Comparative Example 8, respectively, among the above-mentioned catalysts. In these drawings, sign A designates the carbon support which is observed as a blurry dark area, and sign B designates the catalytic metals which are observed as clear black dots. In FIG. 2, sign C designates metal agglomerates. As can be seen from these drawings, the catalyst of Example 8 contains fine catalytic metals having a particle size of about 2 to about 5 nm supported on the support in a very highly dispersed manner, whereas the catalyst of Comparative Example 8 contains a large amount of catalyst components having a particle size of about 10 nm and agglomerates thereof supported on the support.

1. A method for producing an anode catalyst for a polymer electrolyte fuel cell, comprising:
a first supporting step of adhering at least one element selected from the group consisting of the elements of group 4, elements of group 5 and elements of group 6 of the periodic table to a conductive support, and subsequently conducting a heat treatment in a non-oxidizing atmosphere; and
a second supporting step of adhering platinum and ruthenium on the support obtained in the first supporting step, and subsequently conducting a heat treatment in a non-oxidizing atmosphere.

2. The method according to claim 1, wherein the heat-treatment temperature in each of the first and second supporting steps is from 200 to 600° C.

3. An anode catalyst for a polymer electrolyte fuel cell, comprising, as catalytic metal components, platinum, ruthenium and at least one element selected from the group consisting of the elements of group 4, elements of group 5 and elements of group 6 of the periodic table supported on a conductive support as obtained by the method-according to claim 1.

4. An anode catalyst for a polymer electrolyte fuel cell, comprising, as catalytic metal components, platinum, ruthenium and at least one element selected from the group consisting of the elements of group 4, elements of group 5 and elements of group 6 of the periodic table supported on a conductive support, wherein the specific surface area of the catalytic metal components is 60 to 350 m²/g.

5. A polymer electrolyte fuel cell comprising the anode catalyst according to claim 3.

6. A polymer electrolyte fuel cell comprising the anode catalyst according to claim 4.
